(19) United States
(12) Patent Application Publication
(10) Pub. No.: US 2013/0258732 A1
(43) Pub. Date: Oct. 3, 2013

(54) SYSTEM AND METHOD FOR REDUCING REACTIVE CURRENT IN POWER CONVERTER BURN-IN TESTS

(71) Applicants: Huibin Zhu, Westford, MA (US); David Smith, Daleville, VA (US); David Scott Wilmer, Troutville, VA (US)

(72) Inventors: Huibin Zhu, Westford, MA (US); David Smith, Daleville, VA (US); David Scott Wilmer, Troutville, VA (US)

(73) Assignee: GENERAL ELECTRIC COMPANY, Schenectady, NY (US)

(21) Appl. No.: 13/430,826

(22) Filed: Mar. 27, 2012

(51) Int. Cl. H02M 7/44

(52) U.S. Cl. 363/95

(57) ABSTRACT

A system and method for reducing reactive current in burn-in test systems for solar power converters is disclosed. An emulator configured to simulate a DC power source and the power converter subject to the burn-in test can be coupled in a two-unit circulating configuration. An AC feeder line configured to supply power to the two-unit circulating configuration. A controller can be configured to adjust the output of one or more of the emulator and power converter to reduce reactive current flowing in the AC feeder line. For instance, the controller can adjust the modulation of switching devices used in the power converter or emulator to adjust the power factor of various components of the burn-in test system to compensate for the reactive current in the AC feeder line.

### FIELD OF THE INVENTION

The present disclosure relates to burn-in testing of power converters used in solar power generation, and more particularly to systems and methods for reducing reactive current in solar power converter burn-in test systems.

### BACKGROUND OF THE INVENTION

Solar power generation is becoming an increasingly larger source of alternative energy production throughout the world. Solar power generation systems typically include one or more photovoltaic array (PV arrays) having multiple interconnected solar cells that convert solar energy into DC power through the photovoltaic effect. To interface the output of the PV arrays to a utility grid, a solar converter is needed to convert the DC power output of the PV array into a 60/50 HZ AC current waveform suitable for application to the utility grid.

During manufacturing of power converters, burn-in tests are typically conducted to ensure reliability of a power converter before the power converter is used in operation. During the burn-in test, the components of a power converter system are typically subjected to overload conditions to expose potential anomalies or defects in the power converter system.

Burn-in test labs can utilize a two-unit circulating burn-in configuration that includes a PV emulator configured to receive AC power from a medium voltage transformer and configured to provide DC power to the power converter. The solar power converter converts the DC power from the PV emulator into AC power and provides the AC power to the medium voltage transformer. In this manner, power circulates between the PV emulator and the solar power converter during the burn-in test. An AC feeder line can also be coupled to the medium voltage transformer to supply additional power to the two-unit circulating burn-in configuration.

The two-unit circulating burn-in configuration can reduce power requirements of the burn-in lab facility. For instance, for a PV emulator and power converter that are rated at about 600 kW, the AC feeder line needs to only be rated to accommodate about 125 kVA.

While the two-unit circulating burn-in configuration does reduce power requirements, it has been found that the total current draw from the AC grid through the AC feeder line is more than double the real current requirements for the system due to high reactive currents. The excessive reactive current requires higher current ratings and cost for the AC feeder line conductors, circuit breakers, contactor switches, etc., and leads to increased electricity costs for long hours of burn-in testing.

Thus, a need exists for reducing reactive current in a two-unit circulating burn-in test system. A system and method that provides for the automatic reduction of reactive current that reduces the possibility of human error and increases product yield would be particularly useful.

### BRIEF DESCRIPTION OF THE INVENTION

Aspects and advantages of the invention will be set forth in part in the following description, or may be obvious from the description, or may be learned through practice of the invention.

One exemplary aspect of the present disclosure is directed to a burn-in test system for a power converter. The system includes an emulator configured to simulate a DC power source. The emulator is configured to receive an AC input from a transformer and provide a DC output. A power converter is coupled to the DC output of the emulator. The power converter provides an AC output to the transformer. An AC feeder line is configured to provide AC power to the transformer. The system includes a control system configured to control the power converter and the emulator. The control system is configured to reduce the reactive current in the AC feeder line by controlling the output of one of the emulator or the power converter.

Another exemplary aspect of the present disclosure is directed to a method for burn-in testing of a power converter. The method includes coupling a power converter to the DC output of an emulator configured to simulate a DC power source. The emulator is configured to receive an AC input from a transformer and provide a DC output to the power converter. The power converter is configured to provide an

AC output to the transformer. The method further includes providing AC power to the transformer from an AC feeder line and monitoring the current flowing through the AC feeder line. The method further includes controlling one or more of the output of the emulator or the power converter to reduce the reactive current draw through the AC feeder line and conducting at least one burn-in test of the power converter.

A further exemplary aspect of the present disclosure is directed to a burn-in test system. The system includes an emulator and a power converter coupled in a two-unit circulating configuration. The emulator provides a DC output to the power converter. The power converter provides an AC output couplable to an AC input of the emulator. The system further includes an AC feeder line configured to supply power to the two-unit circulating configuration. The system further includes a controller configured to adjust the output of one or more of the emulator and the power converter to reduce reactive current flowing in the AC feeder line.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a block diagram of an exemplary burn-in test system according to an exemplary embodiment of the present disclosure;

FIG. 2 depicts a flow diagram of an exemplary method according to an exemplary embodiment of the present disclosure;

FIG. 3 depicts a flow diagram of an exemplary method according to an exemplary embodiment of the present disclosure; and

FIG. 4 depicts a flow diagram of an exemplary method according to an exemplary embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a system and method for reducing reactive current in a burn-in test system for power converters. The burn-in test system regulates the output of a DC power source emulator or the power converter subject to the burn-in test to reduce the reactive current in an AC feeder line providing power to the burn-in test system. In one implementation, the controller adjusts the power factor at the DC power source emulator and/or the power converter to reduce the reactive current.

The controller compensation method can be used to overcome leaking inductances, such as inductances from transformers used in the burn-in test system that tend to create lagging power factor. In particular embodiments, the controller can execute a control routine that automatically adjusts the output of the DC power source emulator and/or the output of the solar power converter to reduce the net current draw by the burn-in test system such that reactive current compensation can be provided under different load conditions and in situations where transformer impedance may be unknown.

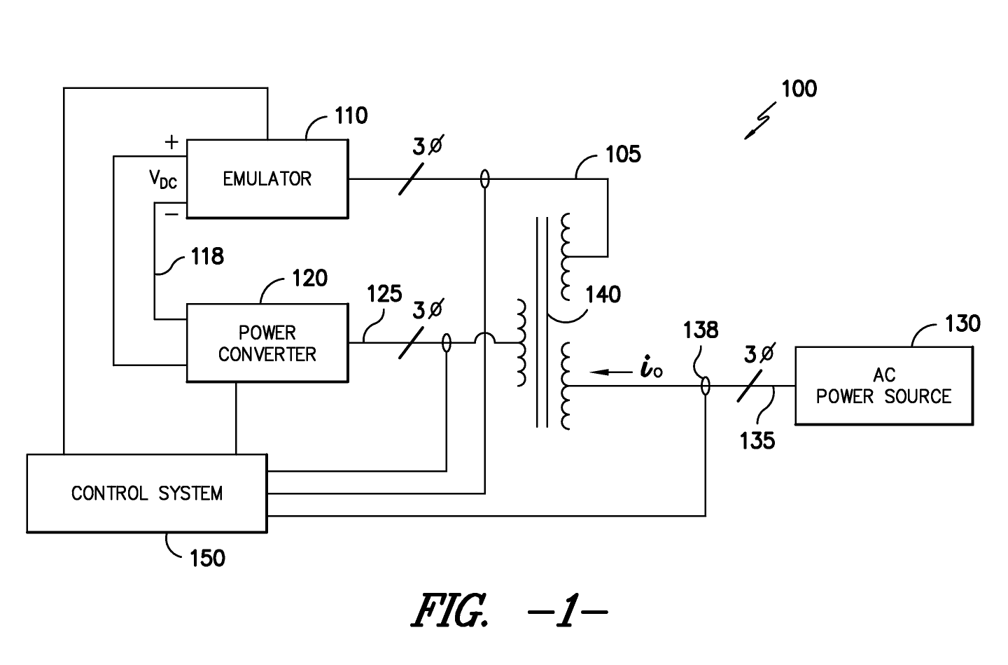

FIG. 1 depicts an exemplary burn-in test system 100 according to an exemplary embodiment of the present disclosure. Burn-in test system 100 includes an emulator 110 configured to simulate a DC power source, such as a PV array. A power converter 120 that is the subject of the burn-in test is coupled to the DC output 115 of the emulator 110. The power converter 110 is configured to convert the DC output of the emulator 110 into AC power.

As shown in FIG. 1, the emulator 110 and the power converter 120 are coupled in a two-unit circulating configuration. In particular, the AC output 125 of the power converter 125 is coupled to the AC input of 105 of the emulator 110 through transformer 140. Similarly, the DC output 115 of the emulator 110 is the input of power converter 120. In this manner, the two-unit circulating burn-in configuration allows for power to circulate from power converter 120 to emulator 110 and back to power converter 120 to reduce the power demand of the burn-in test system 100.

An AC feeder line 135 can be used to supply AC power from an AC power source 130, such as the utility grid, to the two-unit circulating configuration through transformer 140. The AC feeder line 135 can be rated much lower than the ratings of the emulator 110 and the power converter 120 due to the reduced power requirements provided by the two-unit circulating configuration. For instance, in a particular implementation, the emulator 110 and the power converter can be rated to accommodate 600 kW while the AC feeder line can be rated to accommodate 125 kVA.

The emulator 110 is configured to receive an AC input 105 from the transformer 140 and provide a DC output 115. In this manner, the emulator 110 simulates a DC power source, such as a PV array, for the power converter 120 subject to the burn-in test. The emulator 110 can include an AC-to-DC converter that is configured to convert AC power to DC power. The emulator 110 can include a plurality of switching devices, such as insulated gate bipolar transistors (IGBTs), that are used to control the output of the emulator 110. In a particular embodiment, the emulator can include two stages. The first stage can include an AC to DC converter configured to convert the AC power received from the AC input 105 to DC power. The second stage can include a DC to DC converter that is used to adjust the DC voltage of the DC output 115. For instance, the second stage can include a buck converter, a boost converter, or a buck/boost converter.

According to particular aspects of the present disclosure, the emulator 110 can be a power converter that has previously undergone burn-in testing. For instance a power converter can be coupled such that the AC output of the power converter is coupled to the AC input 105. The DC input of the power converter is coupled to the

DC output. In this manner, previously tested power converters can act as the emulator 110 of the burn-in test system.

The power converter 120 is the power converter 120 subject to the burn-in test. The power converter 120 is configured to receive DC power from the DC output 115 of the emulator 110 and provide an AC output 125. The power converter 120 can include a plurality of switching devices, such as IGBTs, that are used to control the output of the power converter 120. The power converter 120 can be a two-stage power converter and can include a DC to DC converter that provides DC power to an inverter. The DC to DC converter can be a buck converter, a boost converter, or a buck/boost converter. The inverter can be configured to convert the DC power to AC power.

As illustrated, the power converter 120 provides an AC output 125 to transformer 140. Transformer 140 can be a medium voltage transformer and can include three windings. The AC output 125 of the power converter 120 can be coupled to a primary winding of the transformer 140. The AC input 105 to the emulator 110 can be coupled to a secondary winding of the transformer 140. The AC feeder line 135 can be coupled to another secondary winding of the transformer 140.

During operation, the AC input of the emulator 110 is coupled to the AC output of the power converter 120. In this manner, the emulator 110 acts as a load on the power converter. Similarly, the input of the power converter 110 is coupled to the DC output of the emulator 110. The power converter 120 thus acts as a load on the emulator 110. This two-unit circulating configuration of the emulator 110 and power converter 120 provides for circulating power flow between the emulator 110 and power converter 120, reducing the power requirements supplied by the AC feeder line 135.

The burn-in test system 100 further includes a control system 150 configured to monitor and control various aspects of the burn-in test system 100, including the emulator 110 and power converter 120. The control system 150 can include any number of control devices, such as a microcontroller(s), microprocessor(s), microcomputer(s), programmable logic controller(s), application specific circuits, or other suitable control device(s). In a particular implementation, the control system 150 can execute computer-readable instructions stored on a computer-readable medium to control various aspects of the burn-in test system.

The control system 150 can send commands to emulator 110 to regulate the output of the emulator pursuant to a control method that regulates the duty cycle of switching devices (e.g. IGBTs or other power electronic devices) used in the emulator 110. The control system 150 can regulate the power factor of the AC input to the emulator by adjusting the output of the emulator 110. In particular, the control system 150 can provide varying modulation commands to the switching devices in the control system 150 to adjust the power factor of the AC input 105 to the emulator 110.

Control system 150 can also regulate the output of the power converter 120 by varying modulation commands provided to the power converter 120. The modulation commands control the pulse width modulation provided by switching devices (e.g. IGBTs or other power electronic devices) to provide a desired real and/or reactive output by the power converter 120. In this manner, the control system 150 can also regulate the power factor of the AC output of the power factor 120. As will be discussed in detail below, the control system 150 can reduce the reactive current in the AC feeder line by regulating the power factor of the AC input 105 and/or the AC output 115.

The control system 150 can include various sensors to monitor aspects of the burn-in test system. For instance, the control system 150 can include a sensor 138 configured to monitor the AC current in the AC feeder line 135. The sensor 138 can include one or more current shunts, Hall effect sensors, or other suitable sensors. The control system 150 can monitor the power factor and/or reactive current of the AC feeder line 135 by monitoring both current and voltage waveforms at the AC feeder line 135. The control system can further monitor the power factor at the AC input 105 to the emulator 110 and the AC output 125 of the power converter 120. The controller 150 can regulate the output of the emulator 110 and power converter 120 based on power factor, current, voltage, and other measurements taken at the AC feeder line 135, AC input 105, and/or AC output 125.

Various factors of the two-unit circulating configuration of the burn-in test system 100 can lead to increased reactive current in the AC feeder line 135. For instance, controller accuracy with respect to power factor regulation for the AC input 105 to emulator 110 and with respect to power factor regulation for the AC output 125 of the power converter 120 can have a significant impact on reactive current in the AC feeder line 135. A slight difference in power factor at the AC input 105 to the emulator 110 or the AC output 125 of the power converter 120 can cause the total current in the AC feeder line 135 to double. For instance, a power factor adjustment between 0.98 and 0.99 can cause a large difference in reactive current in the AC feeder line 135. Impedances of the transformer 140 can cause a further reactive current increase in the AC feeder line 135. This impedance is due primarily to the winding leakage of the primary and secondary windings of the transformer 140.

According to exemplary aspects of the present disclosure, the control system 150 is configured to adjust the output of the emulator 110 and/or the power converter 120 to compensate for the reactive current in the AC feeder line 135. For instance, the control system 150 can send modulation commands to the emulator 110 to adjust the power factor of the AC input 105 to the emulator 110. Similarly, the control system 150 can send modulation commands to the power converter 120 to adjust the power factor of the AC output 125, for instance, by outputting reactive power from the power converter 120.

In a particular implementation, the control system 150 is configured to execute a control routine that is configured to monitor the reactive current in the AC feeder line 135 and selectively adjust the output of the emulator 110 and/or the power converter 120 to reduce the reactive current in the AC feeder line 135. The control routine allows for the automatic reduction in reactive current in the AC feeder line 135 under differing load conditions and in circumstances where impedances of the transformer 140 may be unknown.

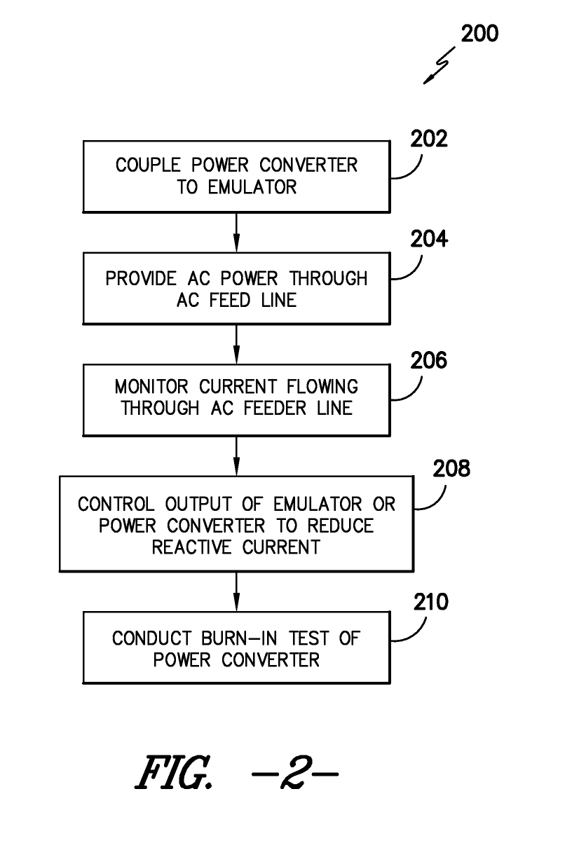

FIG. 2 depicts a flow diagram of an exemplary burn-in test method (200) according to an exemplary embodiment of the present disclosure. The method (200) will be discussed with reference to components of the exemplary burn-in test system 100 of FIG. 1, but can be implemented with any burn-in test system. In addition, although FIG. 2 depicts steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined and/or adapted in various ways.

At (202) the power converter that is subject to the burn-in test is coupled to an emulator configured to simulate a DC power source. For instance, a power converter can be coupled to the DC output of an emulator. In a particular aspect, the power converter and the emulator are coupled in a two-unit circulating configuration as illustrated in FIG. 1 to reduce power demands for the burn-in test system.

At (204), AC power is supplied to the emulator and power converter through an AC feeder line. The AC feeder line can be coupled to the emulator and the power converter through a transformer, such as a medium voltage transformer. The transformer can include a plurality of windings. The AC output of the power converter can be coupled to a primary winding of the transformer. The AC input to the emulator and the AC feeder line can be coupled to secondary windings of the transformer.

At (206), the method includes monitoring the reactive current flowing through the AC feeder line. The reactive current can be monitored by a control system having one or more sensors configured to monitor the reactive current of the AC feeder line. As discussed above, the reactive current in the AC feeder line can be relatively high due to power factor regulation of the emulator and/or power converter and due to leakage inductances of the transformer.

To reduce the reactive current in the AC feeder line, the method can include controlling the output of the emulator and/or the power converter to reduce the reactive current in the AC feeder line (208). For instance, in one aspect, the control system can send modulation commands to the power converter to adjust the reactive power output of the power converter. Adjusting the reactive power output of the power converter will adjust the power factor of the AC output of the power converter. The reactive power output of the power converter will be used to compensate for the reactive current in the burn-in test system, leading to reduced reactive current in the AC feeder line.

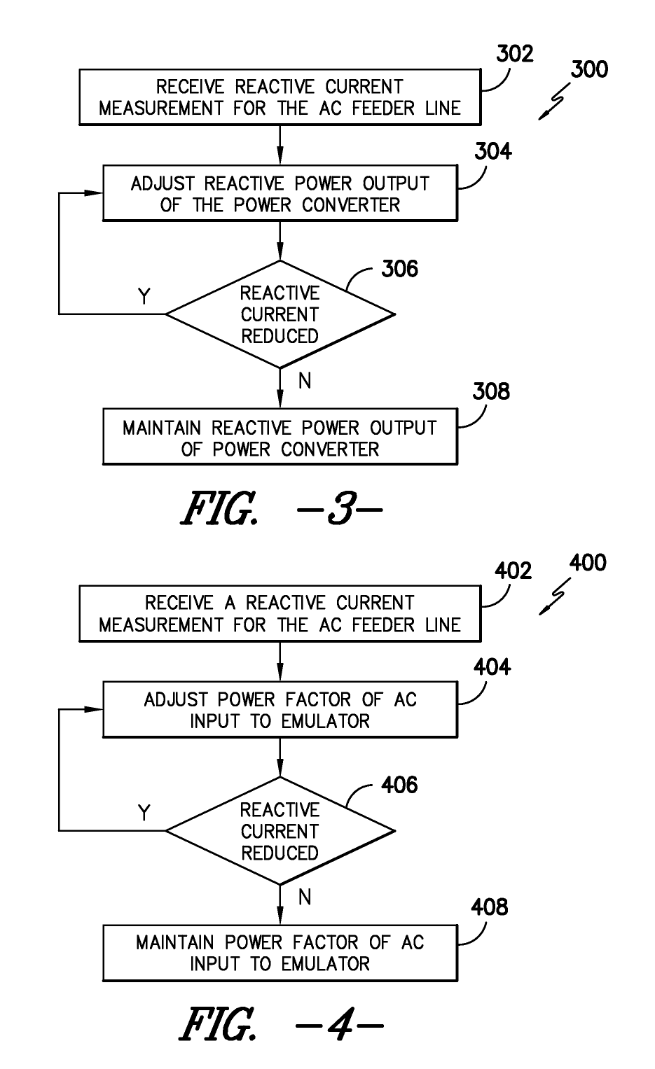

FIG. 3 depicts an exemplary control routine (300) for adjusting the reactive power output of a power converter to provide reduced reactive power in the AC feeder line according to an exemplary embodiment of the present disclosure. The control routine (300) can be implemented by the control system prior to initiating a burn-in test of a power converter to automatically reduce the power demands of the burn-in test. In addition, the control routine (300) can provide for automatic adjustment of power converter output to address changing load conditions to ensure that reactive current in the AC feeder line remains low throughout a burn-in test.

At (302) the control routine performs a measurement of the reactive current for the AC feeder line. The reactive current measurement can be determined from various sensors associated with a control system, such as a current sensor, a voltage sensor, and other sensors. These measurements can be used to compute the reactive current of the AC feeder line.

Once the reactive current measurement has been received, the control routine (304) adjusts the output of the power converter, for instance, by outputting reactive power from the power converter. The control routine then determines whether the reactive current in the AC feeder line has been reduced (306). If so, the control routine continues to adjust the reactive power output of the power converter until the reactive current in the AC feeder line is no longer reduced. If adjustments in the reactive power output of the power converter no longer result in a decrease in reactive current of the AC feeder line, the method maintains the reactive power output of the power converter (308). In this manner, the control routine can automatically identify an optimum reactive power output of the power converter to provide for reduced reactive current in the AC feeder line.

Referring back to FIG. 2 at (208), the method can also control the output of the emulator to reduce the reactive current in the AC feeder line. Adjusting the output of the emulator will adjust the power factor of the AC input of the emulator. This adjustment in power factor of the AC input will be used to compensate for the reactive current in the burn-in test system, leading to reduced reactive current in the AC feeder line.

FIG. 4 depicts an exemplary control routine (400) for adjusting the output of an emulator to provide reduced reactive power in the AC feeder line according to an exemplary embodiment of the present disclosure. The control routine (400) can be implemented by the control system prior to initiating a burn-in test of a power converter to automatically reduce the power demands of the burn-in test. In addition, the control routine (400) can provide for automatic adjustment of emulator output to address changing load conditions to ensure that reactive current in the AC feeder line remains low throughout a burn-in test.

At (402) the control routine performs a measurement of the reactive current for the AC feeder line. The reactive current measurement can be determined from various sensors associated with a control system, such as a current sensor, a voltage sensor, and other sensors. These measurements can be used to compute the reactive current of the AC feeder line.

Once the reactive current measurement has been received, the control routine (404) adjusts the output of the emulator, for instance, by adjusting modulation of switching devices in the emulator. The control routine then determines whether the reactive current in the AC feeder line has been reduced (406). If so, the control routine continues to adjust the output of the emulator until the reactive current in the AC feeder line is no longer reduced. If adjustments in the reactive power output of the emulator no longer result in a decrease in reactive current of the AC feeder line, the method maintains the output of the emulator (408). In this manner, the control routine can automatically identify an optimum reactive power output of the emulator to provide for reduced reactive current in the AC feeder line. While the present subject matter has been discussed with reference to adjusting the output of an emulator or a power converter to obtain a reduction in reactive current, a control routine can be implemented to adjust the output of both the emulator and the power converter can also be adjusted to provide for reduced reactive current in the feeder line.

Referring back to FIG. 2 at (210), once the reactive current in the AC feeder line has been reduced, the method can include conducting a burn-in test of the power converter. The burn-in test can subject the power converter to increased load conditions to identify any anomalies or defects in the power converter. After a successful burn-in test, the power converter can be determined to be adequate for use in converter DC power generated by a PV array into AC power suitable for coupling to the AC grid.

In certain implementations, the power converter can be used as the emulator for the burn-in test system after the power converter has been subjected to the burn-in test. In particular, the AC output of the power converter can be coupled to the AC input from the transformer and the DC input of the power converter can be coupled to the DC input of another power converter being subjected to the burn-in test. The power converter can serve as the emulator for multiple burn-in tests or can be replaced with a new power converter every time a power converter has finished the burn-in test.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A burn-in test system for a power converter, comprising:
an emulator configured to simulate a DC power source, said emulator configured to receive an AC input from a transformer and provide a DC output;
a power converter coupled to the DC output of said emulator, said power converter providing an AC output to the transformer;
an AC feeder line configured to provide AC power to the transformer; and,
a control system configured to control said power converter and said emulator, said control system configured to reduce the reactive current in said AC feeder line by controlling the output of one of said emulator or said power converter.

2. The burn-in test system of claim 1, wherein the AC output of said power converter is coupled to a first winding of the transformer, the AC input of said emulator is coupled to a second winding of the transformer, and the AC feeder line is coupled to a third winding of the transformer.

3. The burn-in test system of claim 1, wherein said power converter comprises an inverter.

4. The burn-in test system of claim 1, wherein said control system is configured to control the output of said emulator and said power converter by controlling the modulation of switching devices in said emulator and said power converter.

5. The burn-in test system of claim 1, wherein said control system is configured to reduce the reactive current in said AC feeder line by monitoring the AC current in said AC feeder line and adjusting the reactive power output of said power converter to reduce the AC current.

6. The burn-in test system of claim 5, wherein adjusting the reactive power output of said power converter comprises adjusting the power factor of the AC output of said power converter.

7. The burn-in test system of claim 1, wherein the control system comprises a current sensor configured to monitor AC current in said AC feeder line, said control system configured to adjust the output of said emulator or said power converter based on a signal provided by said current sensor.

8. The burn-in test system of claim 1, wherein said control system is configured to reduce the reactive current in said AC feeder line by regulating the power factor of the AC input to said emulator.

9. The burn-in test system of claim 8, wherein said control system is configured to regulate the power factor of the AC input to said emulator by controlling the modulation of switching devices in said emulator.

10. The burn-in test system of claim 1, wherein said emulator comprises a power converter that has been subjected to a previous burn-in test.

11. A method for burn-in testing of a power converter, comprising:
coupling a power converter to the DC output of an emulator configured to simulate a DC power source, the emulator configured to receive an AC input from a transformer and provide a DC output to the power converter, the power converter configured to provide an AC output to the transformer,
providing AC power to the transformer from an AC feeder line;
monitoring the current flowing through the AC feeder line;
controlling one or more of the output of the emulator or the power converter to reduce the reactive current in the AC feeder line; and,
conducting at least one burn-in test of the power converter.

12. The method of claim 11, wherein controlling one or more of the output of the emulator or the power converter comprises controlling the modulation of switching devices in the emulator or the power converter.

13. The method of claim 11, wherein controlling one or more of the output of the emulator or the power converter comprises adjusting the reactive power output of the power converter.

14. The method of claim 13, wherein controlling one or more of the output of the emulator or the power converter comprises:
measuring a reactive current flowing in the AC feeder line;
adjusting the reactive power output of the power converter;
determining whether the reactive power is reduced; and,
further adjusting the reactive power output of the power converter until the reactive power is no longer reduced.

15. The method of claim 13, wherein adjusting the reactive power output of the power converter comprises regulating the power factor of the AC output of the power converter.

16. The method of claim 11, wherein controlling one or more of the output of the emulator or the power converter comprises regulating the power factor of the AC input to emulator.

17. A burn-in test system comprising:
an emulator and a power converter coupled in a two-unit circulating configuration, said emulator providing a DC output to the power converter, said power converter providing an AC output that is couplable to an AC input of said emulator;
an AC feeder line configured to supply power to the two-unit circulating configuration; and,
a control system configured to adjust the output of one or more of the emulator and power converter to reduce reactive current flowing in the AC feeder line.

18. The burn-in test system of claim 17, wherein said control system is configured to adjust the output of one or more of the emulator and power converter to reduce reactive current flowing in the AC feeder line by regulating the power factor of the AC input to said emulator.

19. The burn-in test system of claim 18, wherein said control system is configured to adjust the output of one or more of the emulator and power converter to reduce reactive current flowing in the AC feeder line by regulating the power factor of the AC output of said power converter.

20. The burn-in test system of claim 19, wherein said control system is configured to adjust the output of one or more of the emulator and power converter to reduce reactive current flowing in the AC feeder line by regulating the power factor of the AC input of said emulator and the power factor of the AC output of said power converter.
